(19) United States
(12) Patent Application Publication
(10) Pub. No.: US 2003/0135429 A1
(43) Pub. Date: Jul. 17, 2003

(54) Custom engineered product system and process

(76) Inventors: Jean-Luc Pous, Houston, TX (US); David L. Malone, Sugar Land, TX (US); Ian T. Schuur, Houston, TX (US); Peter A. Goode, Houston, TX (US)

Correspondence Address: Schlumberger Technology Corporation, Schlumberger Reservoir Completions, 14910 Airline Road, P.O. Box 1590, Rosharon, TX, 77583-1590, US

(21) Appl. No.: 10/043,856

(22) Filed: Jan. 11, 2002

(51) Int. Cl. G06F 15/16

(52) U.S. Cl. 705/27

(57) ABSTRACT

A system and method for providing custom engineered products. A customer may select from identified unavailable products, attributes, or variances stored in a memory or may input a desired specification. The processor may then be used to compare the customer selection to available products for alternative suggestions and for advanced material ordering among other uses. The processor may also be used to determine the cost of the resources required to provide the custom engineered product. It is emphasized that this abstract is provided to comply with the rules requiring an abstract which will allow a searcher or other reader to quickly ascertain the subject matter of the technical disclosure. It is submitted with the understanding that it will not be used to interpret or limit the scope or meaning of the claims. 37 CFR 1.72(b).

### BACKGROUND OF THE INVENTION p 1. Field of Invention

The present invention relates to the field of supplying custom engineered products. More specifically, the invention relates to a system and process for engineering products and services in rapid response to customer demand.

2. Related Art

Traditionally, when deciding what products to develop, a company will attempt to anticipate the needs or desires of a customer and design a product according to that plan. The planning often involves an evaluation of market surveys, research, and technical capabilities among other factors. To implement the plan, the company then generally completes a product development cycle that involves numerous steps of design, feedback, and redesign. External developments and mistakes can become very costly in such a design or engineering plan and process. Further, once a particular tool is designed, some products require numerous sizes or other modifications or line extensions. The engineering required to make the changes and line extensions can vary from relatively simple to complex.

At the same time, customers have needs that may or may not be addressed by the plans of the product or service provider. Often, such market or customer needs may arise that require a swift reaction. To satisfy these customer needs and to improve their competitive position, companies are continually striving for ways to improve their responsiveness to customer demand.

In one example, a computer manufacturer allows the customer to select from an array of off-the-shelf components. The manufacturer then assembles the computer based upon the customer's input. However, many products do not lend themselves to mere changes in assembled components, but require significant engineering and design to meet the customer's needs.

Accordingly, there is a continuing need for a system and process for rapidly responding to a client's or market's need for engineered or specialty products or services.

### SUMMARY

In general, according to one embodiment, the present invention provides such a system and process for rapidly responding to a client's or market's need for engineered or specialty products or services.

Other features and embodiments will become apparent from the following description, the drawings, and the claims.

### BRIEF DESCRIPTION OF THE DRAWINGS

The manner in which these objectives and other desirable characteristics can be obtained is explained in the following description and attached drawings in which:

FIG. 1 illustrates, in block form, a computer system.

FIG. 2 illustrates, in block form, a computer network/computer system.

FIG. 3 illustrates, in block form, an embodiment of the present invention.

FIG. 4 illustrates an embodiment of the present invention showing an interface.

FIG. 5 illustrates, in block form, an embodiment of the present invention showing a comparison.

FIG. 6 illustrates, in block form, an embodiment of the present invention and showing routing of information.

FIG. 7 illustrates an embodiment of the present invention showing obsolescence of a product.

FIG. 8 illustrates, in block form, an embodiment of the present invention and showing generation and use of a specification.

It is to be noted, however, that the appended drawings illustrate only typical embodiments of this invention and are therefore not to be considered limiting of its scope, for the invention may admit to other equally effective embodiments.

### DETAILED DESCRIPTION OF THE INVENTION

In the following description, numerous details are set forth to provide an understanding of the present invention. However, it will be understood by those skilled in the art that the present invention may be practiced without these details and that numerous variations or modifications from the described embodiments may be possible.

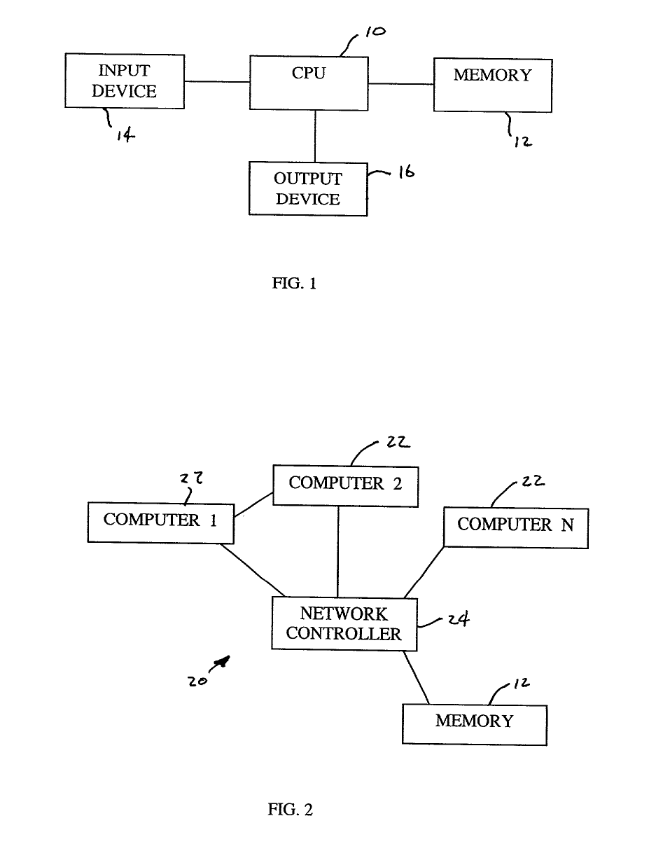

FIG. 1 illustrates in block diagram form an embodiment of hardware that may be used to operate the representative embodiment of the present invention. A central processing unit (“CPU”) 10 is coupled to a memory 12, an input device 14 (i.e., a user interface unit), and an output device 16 (i.e., a visual interface unit). By way of example, the CPU 10 may be a personal computer or other computer. The input device 14 may be a keyboard, mouse, voice recognition unit, or any other device capable of receiving instructions. It is through the input device 14 that the user may make a selection. The output device 16 may be a device that is capable of displaying or presenting data and/or diagrams to a user, such as a monitor. The memory 12 may be a primary memory, such as RAM, a secondary memory, such as a disk drive, a combination of those, as well as other types of memory. Note that the present invention may be implemented in a computer network 20, using the Internet, or other methods of interconnecting computers. An example of a network of computers 22 is shown in block diagram form in FIG. 2. Therefore, the memory 12 may be an independent memory 12 accessed by the network, or a memory 12 associated with on or more of the computers. Likewise, the input device 14 and output device 16 may be associated with any one or more of the computers of the network. Similarly, the system may utilize the capabilities of any one or more of the computers and a central network controller 24. Therefore, a reference to the components of the system herein may utilize any of the individual components in a network of devices. Any other type of computer system may be used. Therefore, when reference is made to “the CPU,” “the memory,” “the input device,” and “the output device,” the relevant device could be any one in the system of computers or network.

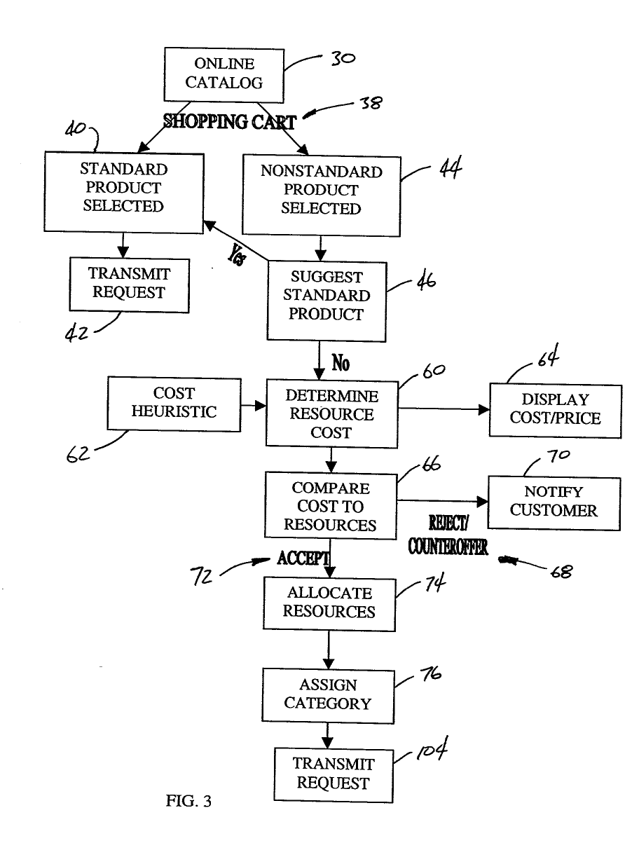

FIG. 3 illustrates an embodiment of the present invention. Customers may access an online catalog 30 on a computer system. The catalog may offer standard, or available, products 32 that may be selected by the customer. In addition, the customer may select unavailable products/attributes 34 (also referred to as nonstandard products/attributes). An unavailable product/attribute 34 is one that the seller does not currently offer and that requires engineering, testing, or both before it may be produced/sold. Generally, these types of products are machined products, although specialty materials may also fall within this category. Also, the unavailable product/attribute 34 may be a variance from an available product 32. As used herein, the terms “customer” and “seller” are used broadly and include not only third party transactions but intercompany transaction in which the seller is one portion of a company and the customer is another portion of a company or organization.

For example, a seller may offer a line of products such as valves via the online catalog 30. The list 33 of standard products 32 identifies the thread types currently available from the seller. However, the online catalog 30 may also offer an unavailable attribute 34 in the form of a different thread not currently offered by the seller. Before the seller can sell the valve with the new thread, the seller must conduct engineering in the form of a drawing change or instructions to the manufacturer (e.g., machine shop).

In another example, a seller offers downhole, oil well packers on the online catalog 30. A customer may desire an unavailable attribute 34 in the form of a seal. The seller must perform engineering, which may comprise testing of the packer with the new seal, before the packer is sold to the customer.

In yet another example, a seller offers a line of downhole, oilfield safety valves listing its standard, available sizes for a given product line (e.g., a tubing retrievable safety valve is offered in 2⅞ inch, 3½ inch, and 4½ inch sizes). In the online catalog 30, the seller also lists an unavailable product 34 in the form of a size not currently available from the seller (e.g., a 7 inch tubing retrievable safety valve). However, before a seller can build the new size, it must be engineered and likely must be tested before delivery. By offering the unavailable size on the online catalog 30, the seller is able to extend their line offering based upon actual market demand as opposed to simply building a new size in the hopes that someone will buy it.

A seller may, as an example, list 35 other unavailable products 34 that are outside of its current offerings. For example, a seller offers a gravel packing service tool for a specific service or that offers certain functionality, but which is simply in the conceptual stage. As an alternative, the tool may be one that is currently being engineered or in the development plan for the seller. A customer order of that product may spur faster development of that tool. The seller may wish to allocate additional resources to development of that tool based upon the market demand. Further, conceptual ideas may be offered and built only after actual customer demand is present.

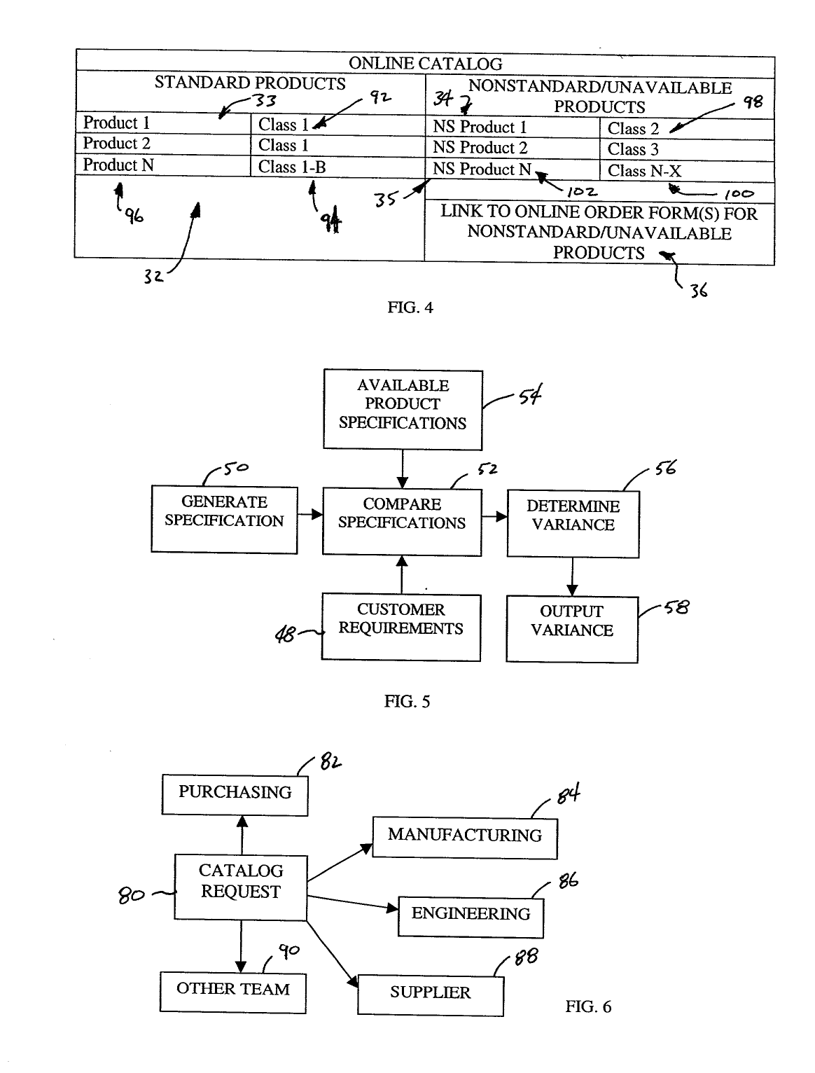

FIG. 4 illustrates a possible embodiment of the present invention in which the online catalog 30 offers a list 33 of standard/available products 32 and a list 35 of unavailable products 34. The lists (33,35) are stored in memory 12 (e.g., as data records) and displayed on the output device 16. A user/customer may select a product from either list (33,35) via the input device 14. In addition to allowing a customer to select unavailable products 34 from a list 35, the online catalog 30 may also provide another type of unavailable product/attribute selector 36 (the list 35 of unavailable products/attributes 34 being a first type). In one embodiment, the unavailable attribute/product selector 36 comprises an online form identified in FIG. 4 as a “Link to Online Order Form(s) for Nonstandard/Unavailable Products.” The online form requests the information from the customer that is pertinent to the type of tool requested (e.g., for a gravel pack service tool the form would request the size, thread, well environment, fluids processed, etc.).

Referring again to FIG. 3, the online catalog 30 may have any form of order processing system which in one embodiment is a “shopping cart” (38) form of online order processing. If a customer orders an available product 32 (step 40), the order may be processed in a conventional manner. For example, the CPU 10 may during the ordering process display a price to the customer on the output device 16 and transmit an electronic transmission (step 42), such as an e-mail, a signal representative of the product. The signal may be a specification that is transmitted to a manufacturing group or other pertinent group or entity (e.g., a third party manufacturer). If the customer selects an unavailable product/attribute 34 (step 44), the following steps may be performed. Note that some of these steps may be skipped or omitted depending upon the sellers needs or the particular order. In one illustrative step, the unavailable product/attribute 34 ordered or customer requirement identified is compared to available products 32 and an alternative available product 32 is suggested (step 46) to the customer in its place. If the customer accepts the suggestion of the standard product 32, the order may then be processed as an available product 32 as discussed above. However, if the customer rejects the suggestion, another step may be performed. The comparison may be accomplished in a variety of ways. In one example illustrated in FIG. 5, a comparison of the customers overall requirements (step 48) may be considered. Also, the CPU 10 may generate or retrieve from memory 12 a specification (step 50) associated with the unavailable product 34. This specification may be compared (step 52) to those of the available products 32 (step 54) to determine the closest match(es) (e.g., those having characteristics similar to the unavailable product specification) which may then be suggested to the customer (see also FIG. 8). To facilitate the comparison, the CPU 10 may access a database of stored specifications (step 54) in memory 12. In the comparison, the CPU 10 may also determine the variance (step 56) between the available product 32 and the specification of the unavailable product 34. The variance may then be presented (step 58) to the customer via the output device 16 for consideration. Also, the variance may be assigned a category of design requirements as previously discussed.

In a second exemplary step, a CPU 10 calculates a resource cost (step 60) for the unavailable product/attribute 34. This may be accomplished using the specification generated by the CPU 10 and/or the identified variance from an available product 32 or a myriad of other variables (e.g., material costs, resource availability, delivery requirements, machining costs, testing costs, and actual/anticipated demand among other many variables). Determination of the cost may be facilitated using a cost heuristic 62 stored in the memory 12 that accounts for the desired variables and may take the form of a resource costing module implemented in the CPU 10. The resource cost may be allocated in pure currency, man-hours, opportunity cost, or some other manner or combination. Once the resource cost is determined, it may be displayed (step 64) on the output device 16 or may be converted into a price to the customer that may then be displayed on the output device 16.

Additionally, the resource cost may be compared (step 66) to the available resources of the seller via the CPU 10. Based upon the comparison, the seller may wish to reject 68 the request from the customer and advise (step 70) the customer of such via the output device 16 or electronic transmission from the CPU 10. In one embodiment, the CPU 10 requires user intervention by the seller before rejecting the request from the customer. For example, the seller may determine during the comparison that it lacks sufficient resources (e.g., engineering personnel) to provide the unavailable products/attribute 34 in the time required by the customer. In that case, the seller may wish to reject the request. When making the rejection, the seller may include a counter-offer however (e.g., offer the product with a later delivery date or with reduced engineering/testing requirements).

If accepted 72, the seller, via the CPU 10, may allocate (step 74) its available resources based at least in part on the resource costs required to complete or provide the unavailable product/attribute 34. As an example, the seller may have a pool of engineers as its engineering resource. This engineering resource may be allocated so as to complete the design, engineering, and/or testing of the unavailable product/attribute 34 as well as the other projects required of the engineering resource. Similarly, base material inventory may be reallocated among projects or products to ensure on-time delivery of all projects and products.

To facilitate pricing, allocation of resources, handling of the order, and for other purposes, the selected unavailable product/attribute 34 may be assigned a category of design requirements (step 76) which may be stored in memory 12 and associated with the unavailable product/attribute 34.

As examples:

A thread change or other minor change may be assigned a first category because the work, and resource cost, required may be relatively lower than other requests.

A designed product that requires testing only may be assigned to a second category.

A conceptual idea that must be completely engineered and tested may be assigned a third category.

Each category may have an associated man-hour requirement, cost, price, or other resource allocation (which may be fixed or a general range). The CPU 10 may select an address to which it sends an electronic transmission based upon the category. For example, for the first exemplary category above, the CPU 10 may send an e-mail to a manufacturing group who can make the thread change locally without engineering department intervention. Whereas, a product falling within the second exemplary category may result in an e-mail to the manufacturing group and a testing group and a product in the third exemplary category may flow to the engineering department. In another example, the e-mail is a signal representative of a request for quotation. FIG. 6 illustrates how the catalog request 80 may be routed to various departments, (e.g., purchasing 82, manufacturing 84, engineering 86, supplier 88, and other groups or teams 90) as required.

FIG. 4 illustrates another type of classification of the products. In one embodiment illustrated in FIG. 4, the products are classified according to the current status of the product. For example, standard products 32 may fall into “Class 1” 92 which may be denoted by a moniker, by the color of the listing (e.g., green for available, red for unavailable), or other identifiable means. The classes may have subclasses as indicated by the notation “Class 1-B” 94 next to “Product N” 96 if desired. In that example, the subclass is indicated by the “B.” A subclass may identify, for example, that the associated product is from a preferred line or older line. Examples of classifications for unavailable products/attributes 34 are, inter alia, a “Class 2” 98 or other classification representing that the product is designed but requires testing, a classification representing that the product is currently being engineered, a classification representing that the product is in a conceptual stage, and a classification representing that the product is designed but obsolete. The nonstandard products 34 may also include subclasses if desired as indicated by the moniker “Class N-X” 100 adjacent the product “NS Product N” 102. In that example, the subclass is indicated by the “X.” The classes and subclasses may be used by the CPU 10 in directing electronic transmissions (step 104) to various addresses associated with predetermined people, departments, or entities.

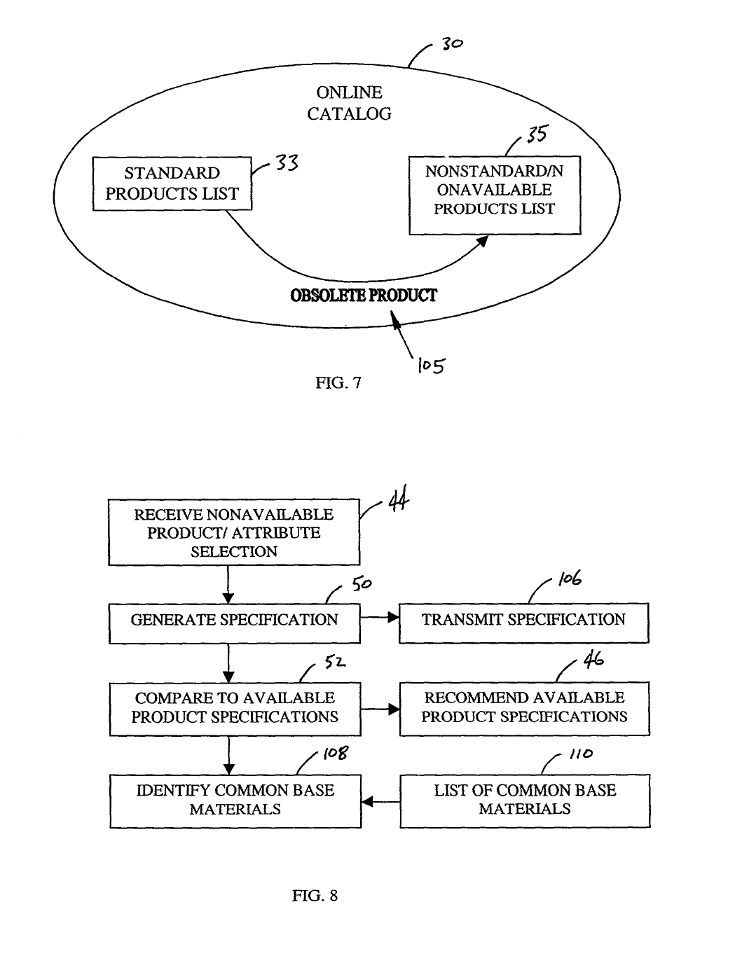

In one embodiment of the present invention, shown in FIG. 7, the online catalog 30 may be utilized to facilitate product rationalization and obsolescence. As shown in the figure, an available product 32 that the seller wishes to obsolete 105 is moved from the available product list 33 to the unavailable product list 35. A customer desiring the obsolete product may be required, for example, to pay a premium for selecting the obsolete product over an available product 32 that has replaced that obsolete product. In this way, the seller can urge the customer to purchase the new product as opposed to the obsolete product.

Another embodiment of the present invention facilitates advanced ordering and manufacture of parts as illustrated in FIG. 8. As previously discussed, the CPU 10 may generate a specification (step 50) for the unavailable product 34 or may retrieve such a specification from memory 12. The CPU 10 may transmit (step 106) this specification to the appropriate predetermined group, individual, or entity as is also previously described. Further, the specification may be compared to the specifications or characteristics of the specifications for the available products 32. The comparison may result in a suggestion (step 46) that one or more standard products 32 be considered rather than the selected unavailable product 34. In addition, however, the comparison may be used to identify (step 108) the base materials in common between the unavailable product 34 and the similar available product 32. The CPU 10, for example, may retrieve a list of base materials 110 for the available product 32 from memory 12 and provide those base materials from that list that are common between the available and unavailable product 34. For example, the CPU 10 may determine that a variance between the product specifications occurs only in one subcomponent. Thus, all of the other components are the same. In another example, the CPU 10 may identify that the diameter and length of the stock materials are the same between the parts. This information of common base components may then be used to advance order the base materials or the common subcomponents. The advance order may occur even before any engineering is conducted or, alternatively, may await such engineering and provide assistance thereto. As an example, the CPU 10 may send an electronic transmission of the common base materials to a predetermined address (e.g., a purchasing department, a manufacturing department, or third party supplier) to begin advance ordering of parts or base materials. As used herein, the term “base materials” comprises stock material as well as machined or prepared subcomponents.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

I claim:

1. A method for providing custom-engineered products, comprising:
providing an online catalog having an unavailable product/attribute selector;
receiving a selection of an unavailable product/attribute that requires one or more of engineering and testing before it may be produced.

2. The method of claim 1, further comprising:
suggesting an existing/standard product based upon and as a replacement for the selection.

3. The method of claim 1, further comprising:
determining a resource cost for the unavailable product/attribute.

4. The method of claim 1, further comprising:
assigning a category of design requirements to the unavailable product/attribute.

5. The method of claim 4, further comprising:
determining a resource cost for the unavailable product/attribute;
assigning a first category to the unavailable product/attribute if the resource cost is relatively lower;
assigning a second category to the unavailable product/attribute if the resource cost is relatively higher.

6. The method of claim 4, further comprising:
transmitting a request for the unavailable product/attribute to an address associated with the assigned category.

7. The method of claim 6, further comprising:
transmitting the request to a manufacturing facility for the unavailable product/attribute if it is assigned to a first predefined category.

8. The method of claim 6, further comprising:
transmitting the request to an engineering department for the unavailable product/attribute if it is assigned to a second predefined category.

9. The method of claim 1, further comprising:
providing a list of available products in the online catalog.

10. The method of claim 1, further comprising:
obsoleting an available product by moving it from the list of available products to a list of unavailable products.

11. The method of claim 1, further comprising:
receiving an order of an available product and transmitting a request to a manufacturing facility.

12. The method of claim 1, wherein the unavailable product/attribute selector comprises a list of unavailable products/attributes.

13. The method of claim 12, further comprising:
classifying an item in the list of unavailable products/attributes.

14. The method of claim 1, wherein the unavailable product/attribute selector comprises an online form.

15. A method for providing available and unavailable products/attributes and for operating an associated computer system having at least one of each of the following:
a central processing unit (CPU);
a visual interface in communication with the CPU;
a memory in communication with the CPU; and
a user interface selection device in communication with the CPU; the method comprising:
displaying a list of available products, stored in a memory of the computer system, on a visual interface of the computer system; and
providing an unavailable product/attribute selector in the computer system.

16. The method of claim 15, further comprising:
storing in a memory of the computer system a list of unavailable products/attributes.

17. The method of claim 16, further comprising:
displaying the list of unavailable products/attributes on a visual interface of the computer system.

18. The method of claim 16, further comprising:
storing in a memory of the computer system a category of design requirements associated with the unavailable products/attributes.

19. The method of claim 15 further comprising:
receiving a selection of an unavailable product/attribute via a selection signal from a user interface selection device of the computer system; and
displaying a resource cost to the unavailable product/attribute on a visual interface of the computer system.

20. The method of claim 15 further comprising:
receiving a selection of an unavailable product/attribute via a selection signal from a user interface selection device of the computer system; and
identifying, by a CPU of the computer system, one or more available products, from the list of available products, that has similar characteristics to those of the selected unavailable product/attribute; and
displaying the identified one or more available products on a visual interface of the computer system.

21. The method of claim 15 further comprising:
generating a specification for a product in response to receiving, by a CPU of the computer system, a selection signal from the user interface selection device of an unavailable product/attribute.

22. The method of claim 21, further comprising:
transmitting from a CPU of the computer system via electronic transmission a signal representative of the specification.

23. The method of claim 21, further comprising:
providing a list of resources in a memory of the computer system; and
allocating the list of resources using a CPU of the computer system, the allocation based, at least in part, upon the specification.

24. The method of claim 21, further comprising using a CPU of the computer system for:
comparing the specification to the list of available products;
selecting an available product, from the list of available products, that has similar characteristics to those of the specification; and
identifying a base material common to the specification and the selected available product.

25. The method of claim 24, further comprising:
providing a list of base materials associated with the available products in a memory of the computer system.

26. The method of claim 24 further comprising:
transmitting from a CPU of the computer system via electronic transmission a signal representative of the base materials identified in the identification step.

27. The method of claim 21, further comprising using at least one CPU of the computer system for:
comparing the specification to the list of available products;
selecting an available product, from the list of available products, that has similar characteristics to those of the specification; and
determining a variance between the specification and the selected available product.

28. The method of claim 27, further comprising using a CPU of the computer system for:
assigning a category of design requirement to the variance.

29. The method of claim 28, further comprising:
transmitting from a CPU of the computer system via electronic transmission a signal representative of the specification to an address associated with the assigned category.

30. The method of claim 29 further comprising:
receiving a selection of an unavailable product/attribute via a selection signal from the user interface selection device;
storing a resource cost heuristic in a memory of the computer system;
calculating a resource cost for the unavailable product/attribute based on the selected unavailable product/attribute and the resource cost heuristic using a CPU of the computer system.

31. The method of claim 29 further comprising:
receiving a selection of an unavailable product/attribute via a selection signal from a user interface selection device of the computer system; and
using a CPU of the computer system for:
calculating a resource cost for the unavailable product/attribute;
comparing the resource cost to a list of available resources;
making an accept/reject decision.

32. The method of claim 29 further comprising:
storing in a memory of the computer system a list of unavailable products; and
moving an item from the list of available products to a list of unavailable products using a user interface selection device of the computer system.

33. The method of claim 29 further comprising:
receiving a selection of an unavailable product/attribute via a selection signal from a user interface selection device of the computer system; and
transmitting from a CPU of the computer system via electronic transmission a signal representative of a request for quotation.

34. A method for offering products, comprising:
providing a set of available product data records in a memory, each available product data record containing a specification for an associated available product;
providing a set of unavailable product data records in the memory, each unavailable product data record containing a specification for an associated unavailable product;
displaying the set of available product data records and the set of unavailable product data records on a visual display;
receiving an input, via a user interface selection device, of a user selection from the set of unavailable product data records.

35. The method of claim 34 wherein at least one of the unavailable product data records is a variance from an available product data record.

36. The method of claim 34 wherein at least one of the unavailable product data records represents an existing, but untested, product.

37. A method for offering custom products, comprising:
receiving into a processor an input, via a user interface selection device, of a specification for an unavailable product;
executing a resource costing module in the processor to determine the resource cost for creating the unavailable product;
transmitting from the processor via electronic transmission a price based upon the resource cost.

38. A method for offering products, comprising:
providing a set of available product data records in a memory, each available product data record containing a specification for an associated available product;
providing a set of variance data records in the memory, each variance data record containing an allowed variance to an associated available product;
displaying the set of available product data records and the set of variance data records on a visual display;
receiving an input, via a user interface selection device, of a user selection from the set of variance data records.

39. A memory structure implemented in a computer system, comprising:
a read/write memory device coupled to the computer system providing the memory structure;
an available product list implemented in the read/write memory;
an unavailable product/attribute selector implemented in the read/write memory allowing selection of products/attributes not currently available from a given provider.

40. The memory structure of claim 39, wherein the unavailable product/attribute selector is an unavailable product/attribute list.

41. The memory structure of claim 39, wherein the unavailable product/attribute selector comprises an unavailable product/attribute request form.
